(19) United States
(12) Patent Application Publication
(10) Pub. No.: US 2005/0159150 A1
(43) Pub. Date: Jul. 21, 2005

(54) Method for communicating data between mobile terminal and personal computer

(75) Inventors: Ho-Hyun Roh, Gumi-si (KR); Yun-Hyang Kim, Gumi-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/038,182

(22) Filed: Jan. 21, 2005

(30) Foreign Application Priority Data
Jan. 20, 2004 (KR) 2004-4259

(51) Int. Cl. H04Q 7/20

(52) U.S. Cl. 455/428

(57) ABSTRACT

A data communication method between a mobile terminal and a personal computer (PC) which can be connected to each other through a communication cable. The method comprises the steps of transmitting a data communication command signal to the mobile terminal through a high speed USB communication protocol and detecting whether the mobile terminal is in a high speed USB communication mode according to a response signal of the mobile terminal, the mobile terminal having a communication mode that can be changed to a high speed USB communication mode according to a command signal. The method further provides steps for reading a data list stored in the mobile terminal when the mobile terminal is in the high speed USB communication mode, detecting a mode and data selected from the read data list so as to execute the data in the high speed USB communication mode, and performing high speed USB communication through a high speed USB communication command packet and a high speed USB communication response packet according to the selected mode.

### CROSS-REFERENCE TO RELATED APPLICATIONS

This application claims the benefit under 35 U.S.C. §119(a) of Korean Patent Application No. 2004-4259 entitled “Method For Communicating Data Between Mobile Terminal And Personal Computer”, filed in the Korean Intellectual Property Office on Jan. 20, 2004, the entire contents of which are incorporated herein by reference.

### BACKGROUND OF THE INVENTION

1. Field of the Invention

The present invention relates to a mobile terminal. More particularly, the present invention relates to a data communication method of a mobile terminal for transmitting mass storage data at a high speed when interchanging data between the mobile terminal and a personal computer (PC).

2. Description of the Related Art

Generally, a mobile terminal displays a specific standby screen image set by a user while it is not in a communication mode but in a standby mode. However, when receiving a call, the mobile terminal outputs a call reception notification sound comprising a specific ringing/melody as set by the user.

Such a ringing/melody and a standby screen image of the mobile terminal are basically stored in the mobile terminal during the manufacturing the mobile terminal. Further, since the ringing/melody and the standby screen image are stored identically in each mobile terminal manufactured, the ringing/melody and the standby screen image often do not satisfy the requirement of the user. Accordingly, the user stores a desired ringing/melody and standby screen image which the user wants and thereafter, the stored ringing/melody and standby screen image are implemented.

Data (i.e., data of the ringing/melody and the standby screen image) which the user wants to use in the mobile terminal are downloaded to the mobile terminal through a wireless application protocol (WAP) connection or a PC.

The WAP connection is provided wherein the mobile terminal itself connects to a data server by means of a WAP, and data is then downloaded from the data server to the mobile terminal. However, the user must pay an information service charge for corresponding data together, with a packet data service charge.

Further, when implementing a method for receiving the data by means of the PC, a 24 pin communication port of the mobile terminal and an RS-232C communication port or a universal serial bus (USB) port of the PC, are connected to each other by means of an RS-232C communication cable or a USB communication cable, and the data stored in the PC is uploaded to the mobile terminal while the PC synchronizes with the mobile terminal. Therefore, the mobile terminal receives the data from the PC.

In contrast, data of the mobile terminal may also be uploaded to the PC. In the communication between the PC and the mobile terminal, data is interchanged by means of a text-based USB protocol. In contrast with the method for receiving the data through the WAP connection, such a data interchange method between the mobile terminal and the PC through the USB protocol has advantages in that it is not necessary for the user to pay for the service charge, and the user can edit and use data as required by utilizing the data stored in the PC.

Many such mobile terminals also have advanced features, such as a camera function and a camcorder function, so that the mobile terminal can photograph objects at any time and regardless of the user's position. Dynamic data photographed in this way is uploaded to the PC through the USB protocol, and dynamic data stored in the PC is downloaded to the mobile terminal. Accordingly, the data is interchanged between the mobile terminal and the PC. That is, the conventional mobile terminal is connected to the PC through a USB communication cable and interchanges data with the PC by means of the USB protocol.

However, in using the data interchange method between the mobile terminal and the PC by means of the text-based USB protocol, the conventional data communication method of the mobile terminal has several problems. One such problem is that an error is not processed in data transmission, thereby causing the data transmission speed and reliability to decrease. Further, since the data transmission time may increase in proportion to the data capacity, a substantially larger time is required when transmitting mass storage data.

Accordingly, a need exists for a system and method for transmitting mass storage data at a high speed when interchanging data between a mobile terminal and a device, such as a personal computer.

### SUMMARY OF THE INVENTION

Accordingly, the present invention has been made to solve the above-mentioned and other problems occurring in the prior art, and an object of the present invention is to provide a data communication method of a mobile terminal for transmitting mass storage data at a high speed when interchanging data between the mobile terminal and a PC.

In accordance with one aspect of the present invention, a data communication method is provided between a mobile terminal and a personal computer (PC) connected to each other through a communication cable. The method comprises the steps of transmitting a data communication command signal to the mobile terminal through a high speed USB communication protocol when the communication cable is connected between the mobile terminal and the personal computer, and detecting whether the mobile terminal is in a high speed USB communication mode according to a response signal of the mobile terminal. The mobile terminal is provided having a communication mode which is changed to the high speed USB communication mode according to the command signal. The method further comprises steps for reading a data list stored in the mobile terminal when the mobile terminal is in the high speed USB communication mode, and detecting a mode and data selected from the read data list so as to execute the data in the high speed USB communication mode. The method further comprises a step for performing high speed USB communication through a high speed USB communication command packet and a high speed USB communication response packet, according to the selected mode.

### BRIEF DESCRIPTION OF THE DRAWINGS

The above and other objects, features and advantages of the present invention will become more apparent from the following detailed description taken in conjunction with the accompanying drawings, in which:

FIG. 1 is a block diagram illustrating the construction of a mobile terminal according to an embodiment of the present invention;

FIG. 2 is a diagram illustrating high speed USB communication modes between a mobile terminal and a PC according to an embodiment of the present invention;

FIG. 3 is a diagram illustrating the structure of a high speed USB communication packet according to an embodiment of the present invention; and

FIGS. 4A to 4C are flow diagrams illustrating a data communication method of a mobile terminal according to an embodiment of the present invention.

Throughout the drawings, like reference numerals will be understood to refer to like parts, components and structures.

### DETAILED DESCRIPTION OF THE EXEMPLARY EMBODIMENTS

Hereinafter, exemplary embodiments of the present invention will be described with reference to the accompanying drawings. In the following descriptions, a detailed description of known functions and configurations incorporated herein will be omitted when it may make the subject matter of the present invention unclear.

In a high speed USB mode, which is described in greater detail below, a high speed USB packet data using a binary-based protocol is interchanged between a mobile terminal and a PC. Further, all numbers used in the high speed USB mode conform to a little-endian. The little-endian denotes a sequence of bytes in which the smallest value in a byte sequence is stored first. In the following description, the PC operates as a master and the mobile terminal operates as a slave.

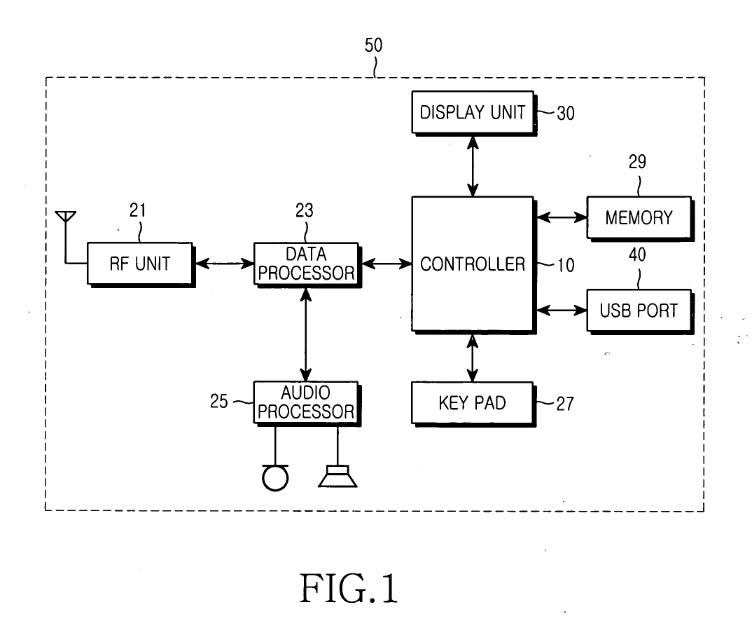

FIG. 1 is a block diagram showing the construction of the mobile terminal according to an embodiment of the present invention. Referring to FIG. 1, an RF unit 21 performs the communication function of the mobile terminal. The RF unit 21 includes an RF transmitter for up-converting a frequency of a transmitted signal and amplifying the transmitted signal, and an RF receiver for low-noise amplifying a received signal and down-converting the frequency of the received signal.

A data processor 23 includes a transmitter for encoding and modulating the transmitted signal, and a receiver for demodulating and decoding the received signal. For example, the data processor 23 may comprise a MODEM (modulator and demodulator) and a CODEC (coder and decoder).

An audio processor 25 reproduces a received audio signal output from the data processor 23, or transfers a transmitted audio signal output from a microphone to the data processor 23. A key pad 27 includes keys for inputting numbers and character information, and further includes various function keys for setting various functions.

A memory 29 may include a program memory section and a data memory section. The program memory section may store programs for controlling the general operation of the mobile terminal and programs for an operation in a high speed USB communication mode. The data memory section temporarily stores data generated in the course of executing the programs, and stores data received from the PC while the mobile terminal operates in a high speed USB communication write mode.

A controller 10 controls the general operation of the mobile terminal and may also include the data processor 23. Further, the controller 10 controls the general operation of the mobile terminal according to the high speed USB communication mode.

A display unit 30 displays messages generated while the programs are executed under the control of the controller 10, and displays user data output from the controller 10. Further, when a USB communication cable connected to the PC is connected to a USB port 40 and thus, the mobile terminal operates in the high speed USB communication mode, the display unit 30 indicates that the mobile terminal is now in the high speed USB communication mode. The display unit 30 may employ an LCD, and in such a case, the display unit 30 may further include an LCD controller, a memory capable of storing image data, and an LCD display device, and so forth. Further, when the LCD employs a touch screen type, the key pad 27 and the LCD may further be used as an input unit.

The USB port 40 is connected to the PC through the USB communication cable and functions as connection means enabling data communication.

Hereinafter, the operation of the mobile terminal will be described in greater detail with reference to FIG. 1. When a call is originated, a user performs a dialing operation through the key pad 27 and sets a calling mode. The controller 10 then detects the setting of the calling mode, processes dial information received through the data processor 23, converts the processed dial information into an RF signal through the RF unit 21, and outputs the RF signal. When a called subscriber generates a response signal, the controller 10 detects the response signal through the RF unit 21 and the data processor 23. A voice communication path is then formed through the audio processor 25 and the user performs a communication function.

In a receiving mode, the controller 10 detects that the mobile terminal is in the receiving mode through the data processor 23, and generates a ring signal through the audio processor 25. When the user responds to the response signal, the controller 10 then detects the response of the user. A voice communication path is then formed through the audio processor 25 and the user performs a communication function. In the calling and receiving modes, voice communication is described as an example. However, a data communication function for communicating packet data and image data may also be performed in addition to the voice communication described above. Further, when the mobile terminal is in a standby mode or performs text communication, the controller 10 displays text data processed through the data processor 23 on the display unit 30.

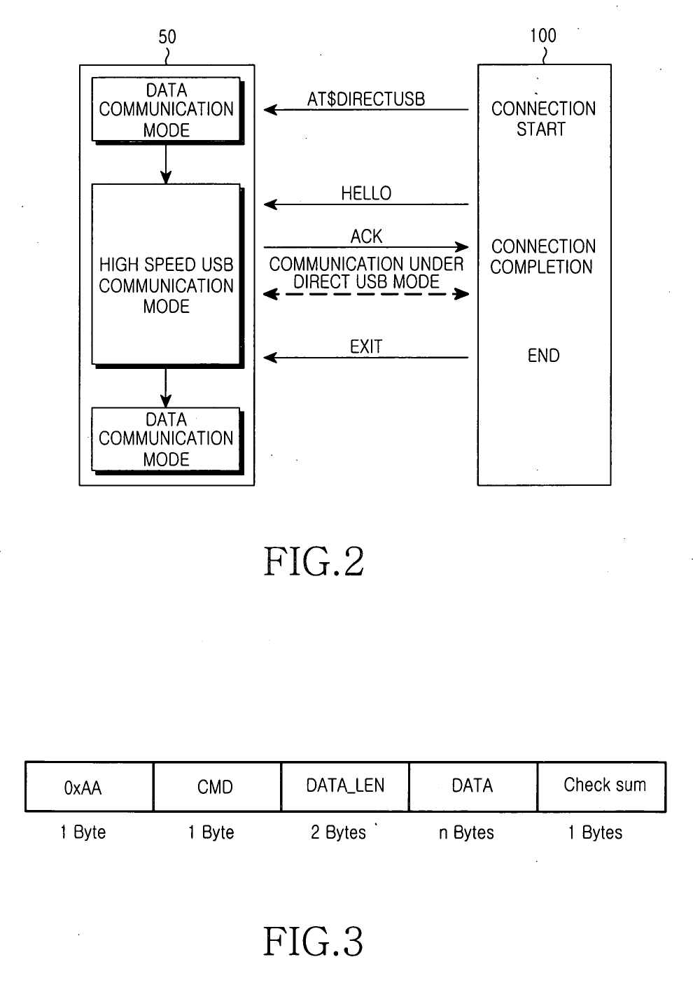

Such a mobile terminal is connected to a PC 100 through a USB communication cable and performs a high speed USB communication mode as shown in FIG. 2. That is, after the PC 100 is connected to the mobile terminal 50 through the USB communication cable, the PC 100 synchronizes with the mobile terminal 50 when the PC 100 executes a data communication program. The PC 100 then transmits a high speed USB data communication ready signal AT$DIRECT USB to the mobile terminal 50.

The PC 100 then transmits a signal HELLO to the mobile terminal 50 for checking whether the mobile terminal 50 is in a high speed USB mode or not, and the mobile terminal 50 transmits a response signal for the signal HELLO to the PC 100. Herein, when normally receiving the signal HELLO for checking whether the mobile terminal 50 is in the high speed USB mode or not, the mobile terminal 50 transmits an ACK signal to the PC 100 as a response signal as shown in FIG. 2. In contrast, when the mobile terminal 50 does not normally receive the signal HELLO, the mobile terminal 50 transmits an NAK signal to the PC 100. When the ACK signal is received in the PC 100, the PC 100 and the mobile terminal 50 start a high speed USB communication mode and interchange data between them.

When the high speed USB communication mode is ended by the user, the PC 100 transmits a signal EXIT to the mobile terminal 50, thereby informing the mobile terminal 50 of the end of the high speed USB communication mode. The mobile terminal 50 then leaves the high speed USB communication mode and enters a general data communication mode so as to be in a standby mode.

Data interchanged between the mobile terminal 50 and the PC 100 is transmitted in a type of single high speed USB communication packet as shown in FIG. 3. The packet includes header information (0×AA), comprising a fixed value notifying that the packet is a high speed USB communication packet of one byte, command or response information (CMD) of one byte, data length information (DATA_LEN) of two bytes, data information (DATA) of predetermined bytes, and a check sum information (Check sum) enabling a reception side to check whether the same number of bits have reached the reception side or not. Herein, when the data length information is 0, the data information does not exist. Further, since a bit error does not often occur in an actual serial communication through a USB, the check sum information inspects whether or not the error exists in the packet during communication by means of an exclusive (XOR) check sum, enabling an error to be detected simply and with relative precision. The check sum information further records a value obtained by XORing the other bytes, except for the bytes of the check sum information in the packet.

For instance, when the high speed USB communication packet includes corresponding information such as H1, C1, L1, D1 and CS data, the CS (check sum) data is calculated by the following Equation (1).
CS=H1\hat{ }C1\hat{ }L1\hat{ }D1 (1)

In Equation (1), the H1 data denotes header information (AA), the C1 data denotes command information and response information (CMD), the L1 data denotes data length (DATA_LEN), the D1 data denotes data information (DATA), the CS data denotes check sum information (Check sum), and the ‘\hat{ }’ symbol denotes an XOR operator.

Such a high speed USB communication packet allows a user to transmit data selected by the user, together with the response information (CMD), by adding the selected data to the data information (DATA) according to the communication mode (i.e., deletion mode, write mode, read mode or file information mode) from the PC 100 to the mobile terminal 50, or from the mobile terminal 50 to the PC 100. A corresponding command of the response information and information values for the response information (CMD) will be described in greater detail below.

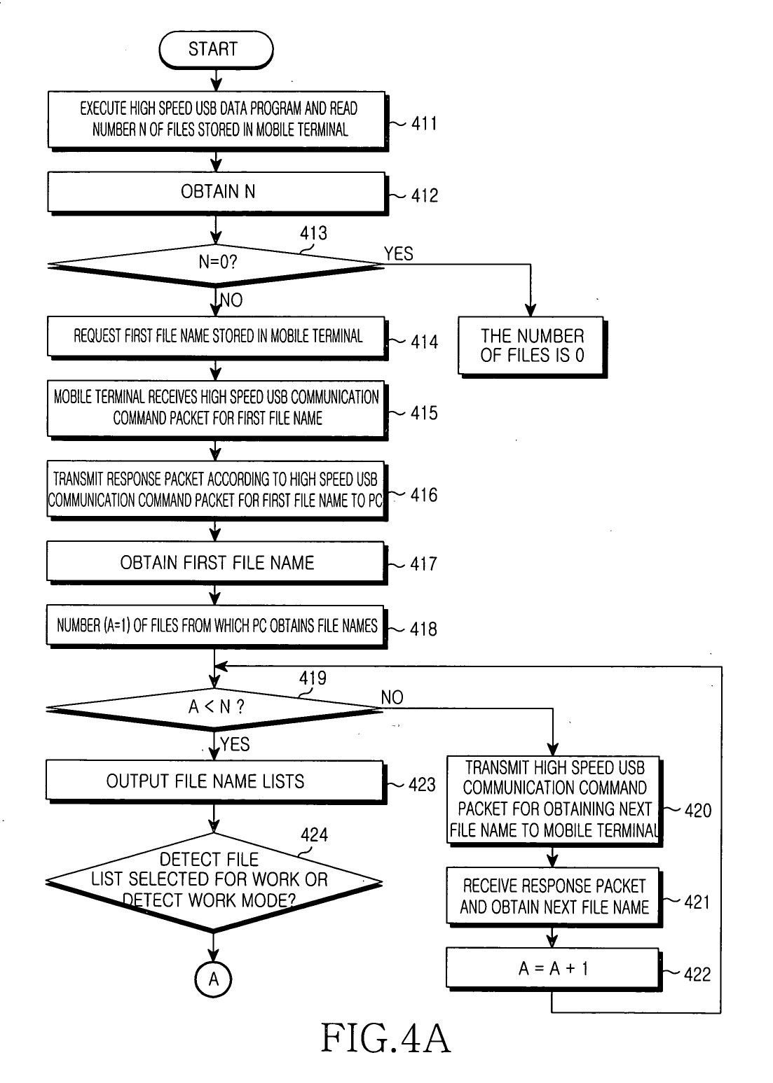

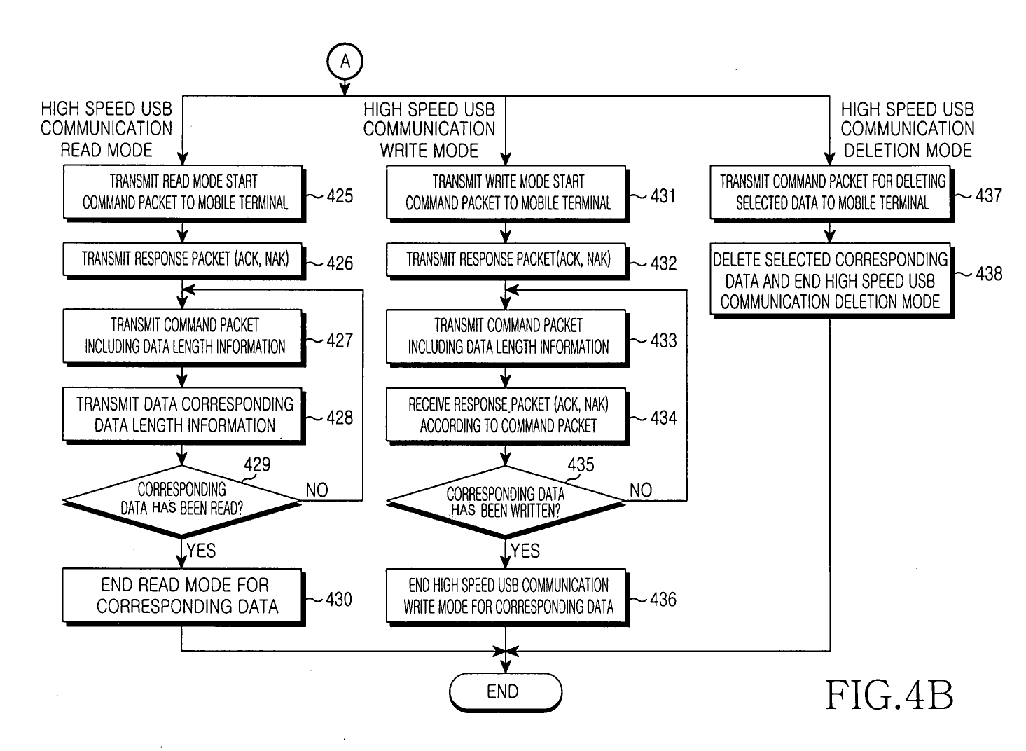

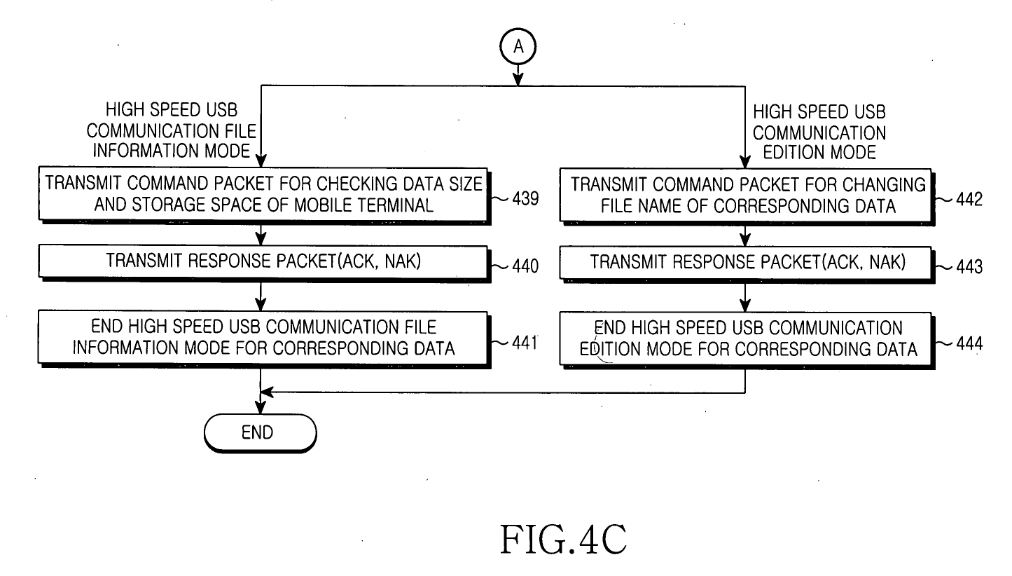

FIG. 4 is a flow diagram illustrating a data communication method of the mobile terminal 50 according to an embodiment of the present invention. A description will be given on an assumption that the mobile terminal 50 has been connected to the PC 100 through a USB communication cable. Further, when the USB communication cable is connected to the mobile terminal 50 and the PC 100, and a high speed USB data program is executed, the PC 100 obtains file system information of the mobile terminal 50. Herein, there further exists a command packet used in obtaining the file system information and a response packet according to the command packet. That is, the command packet as configured as in FIG. 3, includes a “AA, 05, 00, 00, CHECK_SUM”. Further, the mobile terminal 50 transmits a response packet, such as a “AA, 05, LEN_L, LEN_H, INFO_STR, CHECK_SUM”, to the PC 100 in response to the command packet. The INFO_STR includes a maximum size of data capable of being stored in the mobile terminal 50, a maximum size of files capable of being stored in the mobile terminal 50, a maximum size of one file capable of being stored in the mobile terminal 50, and maximum value information of a length of a file name to be stored in the mobile terminal 50.

Referring to FIG. 4, in a first step 411, the PC 100 executes the high speed USB data program and reads the number of files stored in the mobile terminal 50 from the mobile terminal 50. The PC 100 can have information as shown in Table 1 as the command and the response information (CMD) provided according to the command. In step 411, the information of Table 1 becomes command information (CMD).

TABLE 1

| Response and command information | |
|---|---|
| (CMD) | Information value |
| ACK | 0XFF |
| NAK | 0X00 |
| BAD_CHECKSUM | 0X01 |
| HELLO | 0XEE |
| EXIT | 0XDD |
| GET_INFO_STR | 0X05 |
| NUM_FILES | 0X10 |
| RENAME_FILE | 0X12 |
| FILE_SIZE | 0X20 |
| FIRST_FILE | 0X30 |
| NEXT_FILE | 0X40 |
| DELETE_FILE | 0X50 |
| WRITE_OPEN | 0X60 |
| READ_OPEN | 0X70 |
| READ | 0X80 |
| WRITE | 0X90 |
| CLOSE | 0XA0 |
| FREE_SPACE | 0XB0 |

In Table 1, th e“0X” term denotes a hexadecimal.

In step 411, the PC 100 transmits the high speed USB communication packet, including the command information (NUM_FILES:10) for reading the number of the files stored in the mobile terminal 50, as command information.

For instance, the packet can be a “AA, 10, 00, 00, CHECK_SUM”. Herein, the AA denotes header information, the 10 denotes command information (CMD), the first 00 denotes data length information (DATA_LEN), the second 00 denotes data information (DATA) representing absence of data, and the CHECK_SUM denotes a check sum information enabling a reception side to check whether the same number of bits have reached the reception side or not. Hereinafter, descriptions of same elements in the high speed USB packet structure will be omitted, and only different elements will be described. Since the data (DATA) is the high speed USB communication packet for a command for obtaining the number of the files, data (00) does not exist. A high speed USB communication packet for a command, which will be described in greater detail below, is also substantially the same as described above.

In response to the high speed USB communication packet including the command information (CMD), the mobile terminal 50 then transmits a response signal to the PC 100 which is obtained by adding data information (DATA) on the number of the files to an information value equal to that of the command information (CMD). That is, the response signal for the high speed USB communication packet from the mobile terminal 50 may be expressed by “AA, 10, 04, 00, N0, N1, N2, N3, CHECK_SUM”.

In step 412, the PC 100 obtains information on the number N of files stored in the mobile terminal 50 from the mobile terminal 50. The information on the number N of files obtained through step 412 is a factor for determining the number of times for repeating a process in which the PC 100 reads a file name, which will be described in greater detail below, from the mobile terminal 50.

In step 413, the PC 100 determines whether the information on the number N of files is 0 or not. As a result of the determination, step 414 is performed when the information is not 0. That is, the PC 100 requests from the mobile terminal 50 the first file name (FIRST_FILE:30) stored in the memory 29 of the mobile terminal 50. For example, the high speed USB communication command packet for the first file name can be a “AA, 30, 00, 00, CHECK_SUM”.

In step 415, the mobile terminal 50 receives the high speed USB communication command packet requesting the first file name and then proceeds to step 416. In response to the command packet, the mobile terminal 50 transmits a “AA, 30, LEN_L, LEN_H, NAME, CHECK_SUM” to the PC 100 as a high speed USB communication response packet at step 416. Herein, the LEN_L and the LEN_H denote information (little-endian) on data length, and the NAME denotes data information representing the first file name.

In step 417, the PC 100 obtains the first file name stored in the mobile terminal 50. In step 418, the number A of the files from which the PC 100 obtains the file names is 1. In step 419, the PC 100 then determines whether or not the number (A=1) of the files is smaller than the number N of the total files, which are stored in the mobile terminal 50, and obtained through step 412.

As a result of the determination, when the number (A=1) of the files is smaller than the number N of the total files, the PC 100 transmits to the mobile terminal 50 a high speed USB communication command packet requesting a file name next to the first file stored in the mobile terminal 50 in step 420, and proceeds to step 421. In step 421, the PC 100 receives a response packet of the mobile terminal 50 for the high speed USB communication command packet, and obtains the next file name for files after the first file. The PC 100 then transmits the next file name information (NEXT_FILE:40) as command information (CMD). That is, the PC 100 transmits the high speed USB communication command packet “AA, 40, 00, 00, CHECK_SUM” to the mobile terminal 50, and receives a high speed USB communication response packet “AA, 40, LEN_L, LEN_H, NAME, CHECK_SUM”. Herein, the NAME denotes data information (DATA) on the next file name.

In step 422, the PC 100 then increases the number A of the files from which the PC 100 has obtained the file names by 1, and returns to step 419. The PC 100 repeats the above process until the number (A=A+1) of the files, the file names of which have been obtained, is no longer smaller than the number N of the files stored in the mobile terminal 50.

After repeating the above process, step 423 is carried out in order to allow the PC 100 to output a file name list corresponding to the number of the files through an output means, which may include any number of devices, such as a monitor. The PC 100 having obtained the file list through the aforementioned process, can then read and delete data corresponding to the file list and obtain file information. Further, the PC 100 can add specific data to the file list through a write function. Herein, the PC 100 can read and delete the corresponding data of the file list and obtain the file information.

In step 424, the PC 100 detects a file list selected for work from the file list, or detects a work mode selected for work with the detected file list. As a result of the detection of the selected work mode, the PC 100 transmits the command packet to the mobile terminal 50 in step 425 of FIG. 4B when it is detected that the work mode is a high speed USB communication read mode. In this case, the PC 100 transmits the command packet to the mobile terminal 50 by inserting read mode start command information (READ_OPEN:70) into the command information (CMD), and inserting a file name to be read in the read mode into the data information (DATA), so that the selected data can be read in the read mode. That is, the PC 100 commands the start of the read mode through a packet such as a “AA, 70, LEN_L, LEN_H, NAME, CHECK_SUM”. Herein, the NAME denotes a file name selected from the file name list so as to execute the file name in the read mode.

In step 426, the mobile terminal 50 transmits a response packet ACK or NAK for the start command packet of the read mode to the PC 100. When receiving the response packet NAK, the PC 100 retransmits the start command packet of the read mode to the mobile terminal 50.

Upon receiving the response packet ACK, the PC 100 transmits the command packet to the mobile terminal 50 in step 427. In this case, the PC 100 transmits the command packet to the mobile terminal 50 by inserting read command information (READ:80) into the command information (CMD) and inserting data length information to be read from corresponding data into the data information (DATA) in such manner that a predetermined length of the corresponding data of the mobile terminal 50 executed with the read mode can be read. The PC 100 transmits the command packet such as a “AA, 80, LEN_L, LEN_H, READ_LEN_L, READ_LEN_H, CHECK_SUM” to the mobile terminal 50. Herein, the READ_LEN_L and the READ_LEN_H (little-endian) denote the data length information to be read from the corresponding data.

In step 428, the mobile terminal 50 transmits data corresponding to the length of the corresponding data and response information (CMD), which contains information notifying the PC that a high speed USB communication packet is in a read mode, to the PC 100 as a response packet for the read command packet of the PC 100. The mobile terminal 50 transmits the response packet of a high speed USB communication packet such as a “AA, 80, LEN_L, LEN_H, DATA, CHECK_SUM” to the PC 100. Herein, the DATA signifies the data corresponding to a predetermined interval of the corresponding data.

In step 429, the PC 100 detects whether the corresponding data has been completely read from the mobile terminal 50 or not. As a result of the detection, when the corresponding data has been completely read from the mobile terminal 50, the PC 100 ends the high speed USB communication read mode. In contrast, when it is detected that the corresponding data has not been completely read from the mobile terminal 50, the PC 100 repeats steps 427 to 429, and completely reads the corresponding data from the mobile terminal 50. The PC 100 then ends the high speed USB communication read mode in step 430. The PC 100 transmits command information (CMD) containing information A0 reporting the end END of the read mode to the mobile terminal 50. The PC 100 transmits a command packet such as a “AA, A0, 00, 00, CHECK_SUM”.

The mobile terminal 50, having received the command packet, transmits a response packet ACK or NAK to the PC 100. When the response packet for the command packet reporting the end of the read mode is the NAK signal, the PC 100 retransmits the command packet reporting the end of the high speed USB communication read mode to the mobile terminal 50 until the response packet ACK is transmitted from the mobile terminal 50.

Returning to FIG. 4A, as another result of the detection in step 424, the PC 100 transmits the command packet to the mobile terminal 50 in step 431 of FIG. 4B when it is detected that the selected work mode is a high speed USB communication write mode. In this case, the PC 100 transmits the command packet to the mobile terminal 50 by inserting write mode start command information (WRITE_OPEN:60) into the command information (CMD), and inserting a file name to be written in the write mode into the data information (DATA) in such a manner that data can be recorded in the memory 29 of the mobile terminal 50. The PC 100 commands the start of the write mode through a packet such as a “AA, 60, LEN_L, LEN_H, NAME, CHECK_SUM”. Herein, the NAME denotes a file name selected from the file name list so as to execute the file name in the write mode.

In step 432, the mobile terminal 50 transmits a response packet ACK or NAK for the start command packet of the write mode to the PC 100. When receiving the response packet NAK, the PC 100 retransmits the start command packet of the write mode to the mobile terminal 50. Upon receiving the response packet ACK, the PC 100 transmits the command packet to the mobile terminal 50 in step 433. In this case, the PC 100 transmits the command packet to the mobile terminal 50 by inserting read command information (WRITE:90) into the command information (CMD), and inserting length information of data to be written and data information (DATA) into the data length information (DATA_LEN), so that a predetermined length of the corresponding data of the mobile terminal 50 executed with the write mode can be written. The PC 100 transmits the packet such as a “AA, 90, LEN_L, LEN_H, DATA, CHECK_SUM” to the mobile terminal 50. Herein, the LEN_L and the LEN_H (little-endian) denote the length information of the data to be written.

In step 434, the mobile terminal 50 transmits a response packet ACK or NAK for the write command packet of the PC 100 to the PC 100. When receiving the response packet NAK, the PC 100 retransmits the command packet of the high speed USB communication write mode to the mobile terminal 50.

Step 435 is then carried out in order to allow the PC 100 to detect whether corresponding data to be written has been written in the memory 29 of the mobile terminal 50 through the command packet of the high speed USB communication write mode. As a result of the detection, when the corresponding data has not been completely written in the mobile terminal 50, the PC 100 repeats steps 433 to 435.

In contrast, when the corresponding data has been completely written in the mobile terminal 50, the PC 100 ends the high speed USB communication write mode for the corresponding data in step 436. In this case, the PC 100 transmits command information (CMD) containing information A0 reporting the end END of the write mode to the mobile terminal 50, substantially similar to the end of the high speed USB communication read mode. The PC 100 transmits a command packet such as a “AA, A0, 00, 00, CHECK_SUM”. Further, the mobile terminal 50, having received the command packet, transmits a response packet ACK or NAK to the PC 100. Herein, when the response packet for the command packet reporting the end of the write mode is the NAK signal similar to the aforementioned response packet, the PC 100 retransmits the command packet reporting the end of the high speed USB communication write mode to the mobile terminal 50 until the response packet ACK is transmitted from the mobile terminal 50.

Returning to FIG. 4A, as another result of the detection in step 424, when it is detected that the work mode selected in order to work with the selected file list is a high speed USB communication deletion mode, the PC 100 transmits the command packet to the mobile terminal 50 in step 437 of FIG. 4B. In this case, the PC 100 transmits the command packet to the mobile terminal 50 by inserting deletion mode information (DELETE_FILE:50) into the command information (CMD) of a command packet, and inserting a file name of corresponding data into the data information (DATA) of the command packet in order to delete data selected from the file list of the data stored in the memory 29 of the mobile terminal 50. Accordingly, the mobile terminal 50 deletes the selected corresponding data in step 438, transmits a response packet ACK or NAK to the PC 100, and ends the high speed USB communication deletion mode for data selected to be deleted.

As another result of the detection in step 424, when it is detected that the work mode selected in order to work with the selected file list is a high speed USB communication file information mode, the PC 100 transmits the command packet to the mobile terminal 50 in step 439 of FIG. 4C. In this case, the PC 100 transmits the command packet to the mobile terminal 50 by inserting file information mode information (FILE_SIZE:20) into the command information (CMD) of a command packet in order to request information (CMD) on the size of data selected from the file list of the data stored in the memory 29 of the mobile terminal 50. Herein, the high speed USB communication file information command packet is a “AA, 20, LEN_L, LEN_H, NAME, CHECK_SUM”.

In step 440, the PC 100 then receives a response packet transmitted from the mobile terminal 50. The response packet is a “AA, 20, LEN_L, LEN_H, S0, S1, S2, S3, S4, CHECK_SUM”.

Further, the storage space of the memory 29 of the mobile terminal 50 may also be confirmed. Herein, the command packet of file information mode information (FREE_SPACE:B0) is a “AA, B0, 00, 00, CHECK_SUM” and a response packet for the above command packet is a “AA, B0, 04, 00, S0, S1, S2, S3, CHECK_SUM”. When confirmation for the data size or the storage space of the mobile terminal 50 is ended, the PC 100 ends the high speed USB communication file information mode for the corresponding data.

As another result of the detection in step 424, when it is detected that the work mode selected in order to work with the selected file list is a high speed USB communication edition mode, the PC 100 can modify the file name of the corresponding data in step 442 of FIG. 4C. Herein, a command packet is a “AA, 12, LEN_L, LEN_H, NAME 1, NAME 2, CHECK_SUM”. Further, the PC 100 receives a response packet ACK or NAK of the mobile terminal 50 in step 443. The NAME 1 denotes a file name to be modified and the NAME 2 denotes information on a new file name. When modification of the file name of the corresponding data is then ended, the PC 100 ends the high speed USB communication edition mode for the corresponding data at step 444.

As described above, in a data communication method between a mobile terminal and a PC according to embodiments of the present invention, data is interchanged between the PC and the mobile terminal at a high speed according to modes by means of a binary-based high speed USB communication protocol instead of a text-based protocol. According to the present invention as described above, in interchanging data between a mobile terminal and a PC by means of a USB communication cable, mass storage data can be transmitted at a high speed by means of a high speed USB communication protocol, so that high speed data transmission can be performed.

Although exemplary embodiments of the present invention have been described for illustrative purposes, those skilled in the art will appreciate that various modifications, additions and substitutions are possible, without departing from the scope and spirit of the invention as disclosed in the accompanying claims, including the full scope of equivalents thereof.

1. A data communication method between a mobile terminal and a personal computer (PC) connected through a communication cable, the method comprising the steps of:
transmitting a data communication command signal to the mobile terminal through a high speed USB communication protocol when the communication cable is connected between the mobile terminal and the personal computer;
detecting whether the mobile terminal is in a high speed USB communication mode according to a response signal of the mobile terminal, wherein the mobile terminal comprises a communication mode changed to a high speed USB communication mode according to the command signal;
reading a data list stored in the mobile terminal when the mobile terminal is in the high speed USB communication mode;
detecting a mode and data selected from the read data list so as to execute the data in the high speed USB communication mode; and
performing high speed USB communication through a high speed USB communication command packet and a high speed USB communication response packet according to the selected mode.

2. The method as claimed in claim 1, wherein the high speed USB communication mode comprises at least one of a high speed USB communication write mode, a high speed USB communication read mode, a high speed USB communication deletion mode and a high speed USB communication file information mode.

3. The method as claimed in claim 1, wherein the step of reading the data list comprises the steps of:
transmitting a command packet to the mobile terminal requesting a number of files stored in the mobile terminal;
obtaining the number of files stored in the mobile terminal by a response packet of the mobile terminal corresponding to the command packet requesting the number of files; and
obtaining file names in relation to the obtained files according to the number of files stored in the mobile terminal.

4. The method as claimed in claim 1, further comprising the steps of:
transmitting a command packet to the mobile terminal comprising corresponding data to be stored in the mobile terminal and command information of a high speed USB communication write mode when a mode selected is the high speed USB communication write mode so as to execute the data;
receiving a response packet corresponding to the command packet from the mobile terminal; and
determining whether the corresponding data has been recorded in the mobile terminal or not and ending the high speed USB communication write mode when the corresponding data has been recorded in the mobile terminal.

5. The method as claimed in claim 1, further comprising the steps of:
transmitting a command packet to the mobile terminal comprising information of corresponding data to be read from file names stored in the mobile terminal and command information of a high speed USB communication read mode when a mode selected is the high speed USB communication read mode so as to execute the data;
receiving the corresponding data from the mobile terminal through a response packet corresponding to the command packet; and
determining whether the corresponding data has been completely read from the mobile terminal or not and ending the high speed USB communication read mode when the corresponding data has been completely read from the mobile terminal.

6. The method as claimed in claim 1, further comprising the steps of:
transmitting a command packet to the mobile terminal comprising command information requesting deletion of corresponding data stored in the mobile terminal when a mode selected is the high speed USB communication deletion mode so as to execute the data; and
deleting the corresponding data stored in the mobile terminal by the command packet and ending the high speed USB communication deletion mode.

7. The method as claimed in claim 1, further comprising the steps of:
transmitting a command packet to the mobile terminal comprising command information requesting information on a size of selected corresponding data when a mode selected is the high speed USB communication file information mode so as to execute the data; and
receiving a response packet according to size information of data stored in the mobile terminal by the command packet, obtaining file information on the corresponding data, and ending the high speed USB communication file information mode.

8. The method as claimed in claim 1, further comprising the steps of:
transmitting a command packet to the mobile terminal comprising command information requesting confirmation of remaining storage space of the mobile terminal when a mode selected is the high speed USB communication file information mode so as to execute the data; and
receiving a response packet for the remaining storage space of the mobile terminal by the command packet, obtaining information on the remaining storage space of the mobile terminal, and ending the high speed USB communication file information mode.

9. The method as claimed in claim 1, further comprising the steps of:
transmitting a command packet to the mobile terminal comprising command information requesting change of a file name of corresponding data and information containing information on a file name to be changed when a mode selected is the high speed USB communication edition mode so as to execute the data; and
changing the file name of the corresponding data stored in the mobile terminal to a new file name by the command packet and ending the high speed USB communication file information mode.

10. The method as claimed in claim 1, wherein the high speed USB communication command packet comprises:
header information notifying that the high speed USB communication command packet contains high speed USB communication data;
command information according to the command packet;
information on data to be actually transmitted; and
check sum information for checking an error of the command packet.

11. The method as claimed in claim 1, wherein the high speed USB communication response packet comprises:
header information notifying that the high speed USB communication response packet contains high speed USB communication data according to the high speed USB communication command packet;
response information equal to command information of the command packet;
information on data to be actually transmitted according to the command packet; and
check sum information for checking an error of the response packet.

12. The method as claimed in claim 1, wherein the PC transmits a command packet to the mobile terminal including command information for reading corresponding data stored in the mobile terminal when the high speed USB communication mode is a high speed USB communication read mode.

13. The method as claimed in claim 12, wherein, in the high speed USB communication read mode:
the PC transmits a command packet to the mobile terminal including command information for commencing pre-reading before the corresponding data stored in the mobile terminal is read; and
the PC transmits a command packet including command information requesting an end of the read mode for the corresponding data to the mobile terminal when the high speed USB communication read mode is ended.

14. The method as claimed in claim 1, wherein, when the high speed USB communication mode is a high speed USB communication write mode:
the PC transmits a command packet to the mobile terminal including command information for writing data of the PC in the mobile terminal; and
the PC transmits a command packet including command information requesting an end of the write mode for the corresponding data to the mobile terminal when the high speed USB communication write mode is ended.

15. The method as claimed in claim 14, wherein, in the high speed USB communication write mode:
the PC transmits a command packet to the mobile terminal including command information for commencing pre-writing before the corresponding data stored in the PC is written in the mobile terminal.

16. The method as claimed in claim 1, wherein, when the high speed USB communication mode is a high speed USB communication deletion mode:
the PC transmits a command packet to the mobile terminal including command information for deleting data stored in the mobile terminal.

17. The method as claimed in claim 1, wherein, when the high speed USB communication mode is a high speed USB communication file information mode:
the PC transmits a command packet to the mobile terminal including command information for checking information on a size of data stored in the mobile terminal.

18. The method as claimed in claim 1, wherein, when the high speed USB communication mode is a high speed USB communication file information mode:
the PC transmits a command packet to the mobile terminal including command information for checking remaining data space of the mobile terminal.
